(19) United States
(12) Patent Application Publication
(10) Pub. No.: US 2019/0228745 A1
(43) Pub. Date: Jul. 25, 2019

(54) GUITAR AND BRIDGE ASSEMBLY

(71) Applicant: DNA GUITAR COMPANY, Colfax, CA (US)

(72) Inventor: David Randall Johnston, Colfax, CA (US)

(21) Appl. No.: 16/256,851

(22) Filed: Jan. 24, 2019

Related U.S. Application Data
(60) Provisional application No. 62/621,432, filed on Jan. 24, 2018.

(51) Int. Cl. G10D 3/04; G10D 3/10

(52) U.S. Cl. CPC G10D 3/04; G10D 3/10

(57) ABSTRACT

A guitar and bridge assembly includes a body that has a pocket defining a plurality of blind holes. A plurality of inserts each having at least one exterior thread is received by a respective one of the blind holes. A base of a bridge is received by the pocket, and the base has a plurality of through holes. A plurality of fasteners is received through the through holes in the base and is received in threaded engagement with the plurality of inserts. The bridge supports a plurality of strings.

### CROSS-REFERENCE TO RELATED APPLICATIONS

This application is a non-provisional of and claims priority to U.S. Provisional Patent Application No. 62/621,432, entitled “Guitar and Bridge Assembly,” and filed on Jan. 24, 2018, the disclosure of which is incorporated herein by reference.

### BACKGROUND OF THE INVENTION

### Technical Field of the Invention

The present invention relates generally to guitars, particularly electric guitars and electric bass guitars, and more particularly to a robust guitar and bridge assembly.

### Description of Related Art

The sustain characteristics of a stringed instrument, such as an electric guitar or electric bass guitar, depends on the connection between the bridge and the body of the guitar. Conventional bridge attachment employs wood screws that are inserted directly into the wood of the guitar body. Over time, these wood screws may strip or loosen, which may cause the bridge to lose contact with the body. Sustain characteristics diminish when the bridge is not securely fixed to the body, particularly if there are gaps between the loosely attached bridge and the body.

Sustain characteristics can be improved by more tightly securing the bridge to the guitar body.

### SUMMARY

In accordance with an embodiment, a guitar and bridge assembly includes a body that has a pocket defining a plurality of blind holes. A plurality of inserts each having at least one exterior thread is received by a respective one of the blind holes. A base of a bridge is received by the pocket, and the base has a plurality of through holes. A plurality of fasteners is received through the through-holes in the base and is received in threaded engagement with the plurality of inserts. The bridge supports a plurality of strings.

Technical advantages include a more secure connection between the bridge and the body of the electric guitar. The fasteners may be torqued into the inserts with increased torque to create a more robust connection. Sustain characteristics of the guitar or bass are enhanced by a tight connection between the bridge and the guitar. According to some embodiments, the guitar may be made to be lighter without diminishing the guitar's sustain.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 is an isometric view of a guitar with a bridge attached according to the teaching of the present disclosure;

FIG. 2 is a detailed, exploded, isometric view of attachment of a bridge to a guitar body according to the teachings of the present disclosure; and

FIG. 3 is a detailed view of the attached bridge assembled with strings.

### DETAILED DESCRIPTION OF THE DRAWINGS

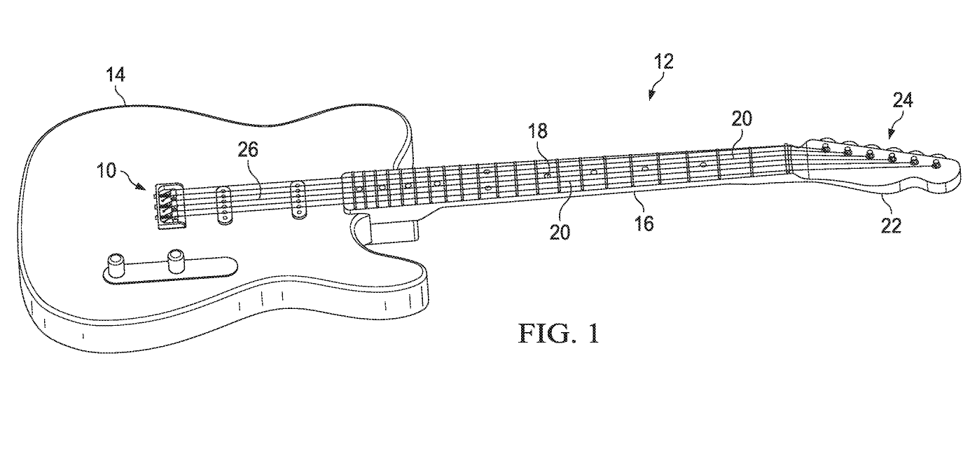

Reference is made to FIGS. 1-3. FIG. 1 shows an isometric, environmental view of an electric guitar 12 with a bridge 10 securely fixed to a body 14 of the guitar 12 according to the teachings of the present disclosure. The teachings disclosed herein apply to any stringed instrument that includes a bridge. An electric guitar or electric bass is used as an example to explain the bridge assembly. A six string electric guitar is shown, but this disclosure is not limited to a six-string electric guitar. The electric guitar 12 may be an electric bass guitar, a 12-string guitar, or other stringed instrument with a solid body and any number of strings. The body may be formed of any suitable material including wood, graphite, carbon fiber, or composite material.

The electric guitar 12 includes a neck 16 extending from the body 14, and a finger board 18 mounted over both the neck 16 and a portion of the body 14 opposite the bridge 10. The finger board 18 has frets 20 disposed at predetermined locations along its length. This disclosure contemplates any number of frets 20 along the finger board 18. A head 22 is disposed at the end of the neck 16 opposite the body 14. The neck 16 includes a plurality of tuning peg assemblies 24, also referred to as tuning machines. An end of a string 26 is secured to a tuning machine 24. The end of the string 26 opposite the tuning machine 24 is supported by the bridge 10.

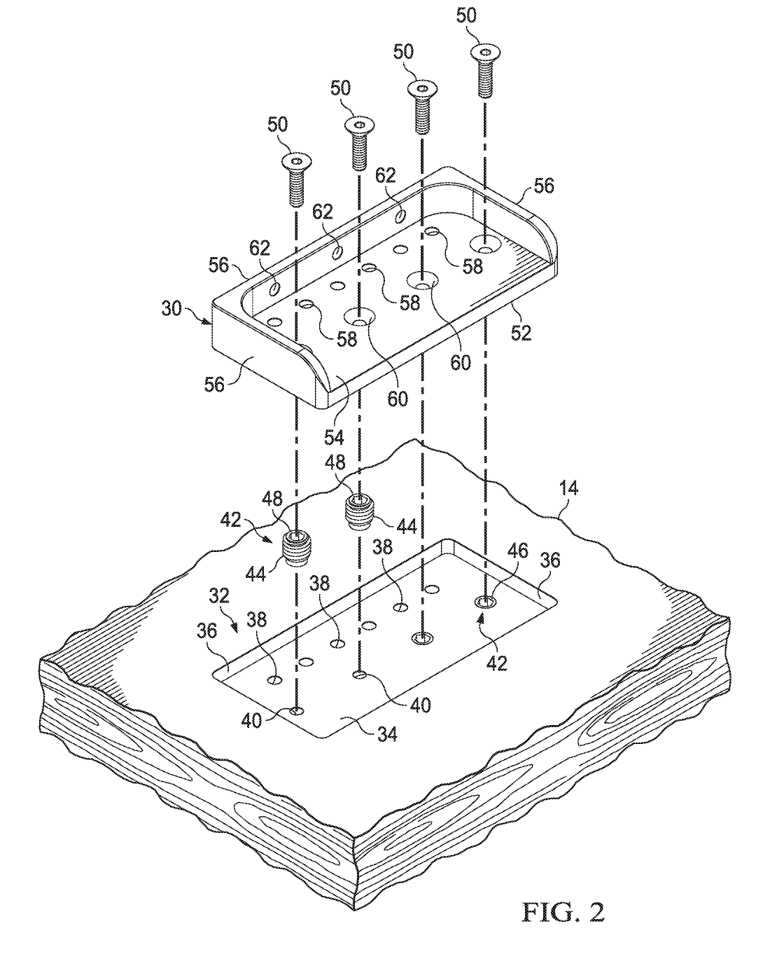

Reference is made to FIG. 2, which is a detailed, exploded view showing the attachment of the bridge 10, and more specifically, a base 30 of the bridge 10 to the body 14. A pocket 32 is formed in the body 14. The pocket 32 has a generally rectangular shape, but any suitable shaped pocket 32 is contemplated by this disclosure. The pocket 32 includes a pocket floor 34 and perimeter walls 36 extending a height above the pocket floor 34. The height of the pocket perimeter walls 36 corresponds to a depth of the pocket 32.

The pocket 32 is formed by routing and removing material (wood, but may be any suitable material) from the body 14. The body 14 is generally a solid piece of wood that has been shaped to include contours, as shown in FIG. 1. The wood may be any suitable type, for example ash, mahogany, pine, or maple or other suitable types of wood known by luthiers to be suitable for guitars and basses. Alternatively, the body 14 may be shaped from a blank of graphite. According to one embodiment, the router is computer-numerical controlled (CNC) to allow dimensions of the pocket to be controlled to tight tolerances, for example plus or minus one one-thousandth of an inch. Tight tolerances ensure a precise press-fit of the base 30 of the bridge 10 into the pocket 32. The depth of the pocket 32 is generally equal to a thickness of a floor 54 of the bridge base 30. According to an embodiment, the pocket depth and thickness of the floor 54 is about 0.125 of an inch. Alternatively, the pocket may be routed using a routing tool other than a CNC router.

A plurality of string holes 38 are drilled or otherwise formed in the pocket 32. According to certain embodiments, the string holes 38 extend completely through the body 14. One string hole 38 is formed for each string 26. The string 26 is threaded through each hole 38 and tied at the backside of the body 14 to prevent it from backing through the string hole 38. A plurality of insert holes 40 are also formed in the floor 34 of the pocket 32. The blind insert holes 40 are drilled or otherwise formed to have a diameter to receive a threaded metal insert 42. According to certain embodiments, the diameter of the insert holes 40 is about 0.25 inch. The location and number of insert holes 40 correspond to the location and number of fastener holes 60 in the floor 54 of the base 30 of the bridge 10. In the illustrated embodiment, four insert holes 40 are formed in the floor 34 of the pocket 32.

The threaded metal inserts 42 are secured within the blind insert holes 40. The threaded metal inserts 42 may be made of any suitable material, such as any metal, for example brass or steel. Alternatively, the inserts may be made of graphite or a composite material. An outer surface of the metal insert 42 includes at least one thread 44. When the insert 42 is screwed into the insert holes 40, the threads 44 cut and carve into the walls of the insert holes 40 to secure the insert 42 into the body 14. The insert 42 is screwed into the insert hole 40 until an upper surface 46 of the insert 42 is generally flush with the floor 34 of the pocket 32. According to alternate embodiments, the insert 42 may be slightly countersunk such that the upper surface 46 is slightly below the floor 34 or the upper surface 46 of the insert 42 may be slightly above the floor surface 34. The outer threads 44 of the insert 42 are configured to more securely grip and hold the wood of the body 14 than the threads of a wood screw.

An inner surface 48 of the threaded metal insert 42 is configured to receive and mate with a fastener 50, such as a machine screw. The inner surface 48 of the threaded metal insert 42 may have a thread or the fastener 50 may tap the thread as it is rotated into a softer material of the insert 42. In either event, the fastener 50 is tightly secured within the threaded metal insert 42, and the threaded metal insert 42 is tightly secured into the insert hole 40.

After the string holes 38 are drilled into the pocket 32 and the four inserts 42 are rotated into the insert holes 40, the base 30 of the bridge 10 is press-fit into the pocket 32. A mallet or similar instrument may be used to tap the base 30 into the pocket 32 to ensure that the base 30 is fully seated in the pocket 32. In certain embodiments, a bottom surface 52 of the base 30 is in contact with the floor 34 of the pocket 32. As stated above, forming the pocket 32 with tight tolerances facilitates a secure press fit. The bridge base 30 may be machined or cast from any suitable metal, such as brass or stainless steel.

The base 30 of the bridge 10 includes a floor 54 and three side walls 56 disposed around the perimeter of the base 30. The base 30 also includes a plurality of string holes 58 and a plurality of fastener receiving through holes 60. The rear perimeter side wall 56 includes through holes 62 to which saddle assemblies are mounted. The fastener holes 60 may be countersunk to ensure that a head of the fasteners 50 are disposed below a top surface of the floor 54 of the base 30.

After the base 30 is seated in the pocket 32, the fastener receiving holes 60 in the floor 54 of the bridge base 30 align with the threaded inserts 42. The fasteners 50, such as machine screws, are received through the fastener holes 60 in the floor 54 of the base 30 and are received in threaded engagement with the inserts 42. According to an embodiment, the fasteners 50 may be torqued into the threaded inserts 42 with a higher torque than conventional attachment of wood screws directly into the body 14. The higher torque creates a more secure connection between the base 30 of the bridge 10 and the pocket 32. Higher torques result due to the configuration of the outer thread 44 of the insert 42 and the greater surface area on the threaded insert 42 that is in contact with the wood than if a wood screw were used without the threaded insert. Thus, the insert 42 can endure higher torques without stripping the wood than a wood screw can endure before stripping the wood.

A more robust connection of the bridge base 30 to the floor 34 of the pocket 32 and contact between the base 30 and the side walls 36 of the pocket 32 results in increased sustain characteristics of the electric guitar 12 and electric bass. In addition, the tighter the bridge base 30 is secured within the pocket 32, the less likely prolonged use will result in gaps between the base 30 and the pocket 32. This robust, secure connection between the base 30 and the pocket 32 also enables the body 14 of the instrument to be made lighter without losing sustain characteristics that may be found in lighter guitars.

Insetting the bridge base 30 into the body 14 of the guitar 12 provides five points of contact between the bridge 10 and the guitar body 14. Four points of contact are made between the side walls 36 of the pocket 32 and the bridge base 30, and the fifth point of contact is made between the bottom surface 52 of the bridge base 30 and the floor 34 of the pocket 32.

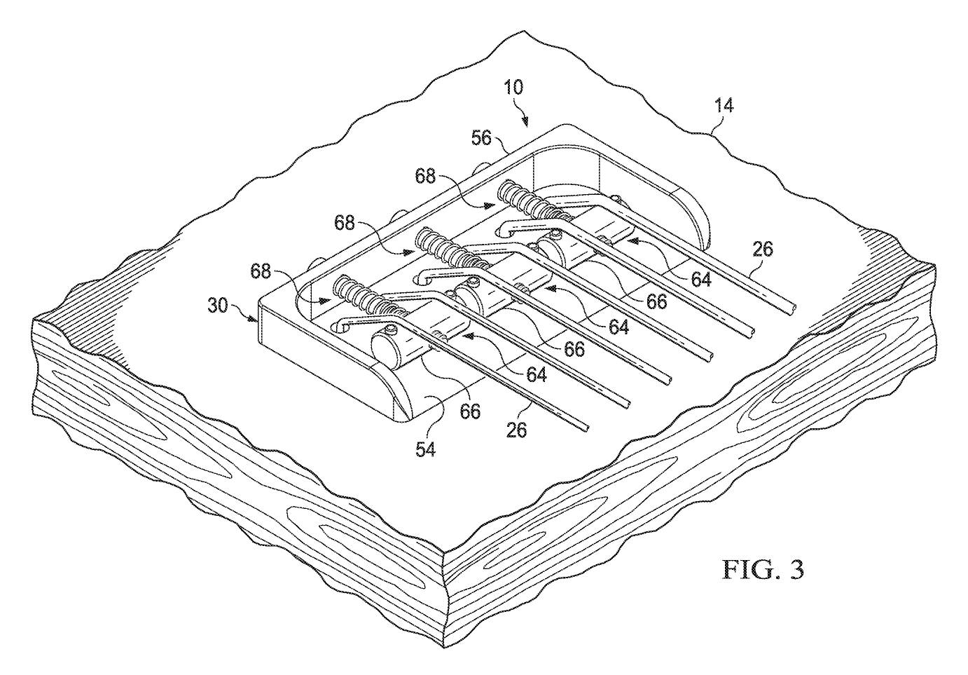

Reference is made to FIG. 3, which is a detailed view of the bridge 10 with attached strings 26. Each string 26 is supported by a saddle assembly 64. The saddle assembly 64 includes a saddle 66 and a saddle adjustment mechanism 68. The saddle assemblies 64 are attached to the bridge base 30 using the through holes 62 in the rear side wall 56. According to some embodiments, one saddle assembly 64 supports multiple strings 26. For example, the saddle assembly 64 may include a single saddle bar supporting multiple strings, or the saddle assembly 64 may include one saddle per string. The adjustment mechanisms 68 screw allow adjustment of the saddle assemblies 64 to ensure proper clearance of the strings 26 from the instrument while also ensuring the strings are disposed close enough such that their vibrations are properly received by the pick-ups, converted into electrical signals, amplified, and played through a speaker.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A guitar and bridge assembly, comprising:
a body having a pocket defining a plurality of holes;
a plurality of inserts each having at least one exterior thread and each being received in a respective one of the holes;
a base of a bridge inserted into the pocket and having a plurality of through holes;
a plurality of fasteners received through the through holes and in threaded engagement with the plurality of inserts, wherein the bridge supports a plurality of strings.

2. The assembly of claim 1 wherein the pocket includes a floor and perimeter side walls and wherein the base contacts the floor of the pocket and the perimeter side walls.

3. The assembly of claim 2 wherein each of the inserts comprises brass.

4. The assembly of claim 2 wherein the plurality of inserts comprises at least four inserts.

5. The assembly of claim 1 wherein the pocket further defines a plurality of pocket through holes configured to receive the strings.

6. The assembly of claim 1 wherein a depth of the pocket is about ⅛ of an inch.

7. The assembly of claim 6 wherein a thickness of a base floor of the bridge is about ⅛ of an inch.

8. The assembly of claim 1 further comprising a neck extending from the body.

9. The assembly of claim 1 wherein the plurality of fasteners is a plurality of machine screws each in threaded engagement with a respective insert.

10. A method for attaching a bridge to a body of a stringed instrument, comprising:
forming a pocket in the body;
forming a plurality of holes in the pocket;
inserting an insert into each of the plurality of holes;
inserting a base of a bridge into the pocket, the bridge including a plurality of through holes; and
rotating a fastener into threaded engagement with each of the inserts, each fastener being received through a respective one of the plurality of through holes.

11. The method of claim 10 wherein forming the pocket comprises routing the pocket with a computer-numerical controlled router.

12. The method of claim 10 wherein inserting the base of the bridge comprises tapping the base with an instrument to press-fit the base into the pocket.

13. The method of claim 10 further comprising forming a plurality of string holes in the pocket, the string holes extending completely through the body.

14. The method of claim 10 wherein the fasteners are machine screws.

15. The method of claim 10 wherein the inserting each of the inserts into the pocket comprises cutting into walls of the blind holes.
